(19) United States
(12) Patent Application Publication
(10) Pub. No.: US 2011/0271316 A1
(43) Pub. Date: Nov. 3, 2011

(54) SET TOP BOX AND METHOD OF ESTABLISHING TV PROGRAM TABLE

(75) Inventors: YAN-ZHI WANG, Shenzhen City (CN); WEI-WEI YIN, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD ., ShenZhen City (CN)

(21) Appl. No.: 12/939,100

(22) Filed: Nov. 3, 2010

(30) Foreign Application Priority Data
Apr. 29, 2010 (CN) 201010157859.5

(51) Int. Cl. H04N 7/173

(52) U.S. Cl. 725/110; 725/131; 725/151

(57) ABSTRACT

A set top box (STB) for establishing a television (TV) program table, and comprises a searching module and a program establishing module. The STB searches a predetermined channel among multiple channels provided by a TV station office server to receive an extensible markup language (XML) file comprising TV program information transmitted by the TV station office server over the predetermined channel. The STB analyzes the XML file to obtain the TV program information and establishes a TV program table according to the TV program information.

### BACKGROUND

1. Technical Field

Embodiments of the present disclosure relate to digital television devices, and more particularly to a set top box and a method of establishing a TV program table.

2. Description of Related Art

Usually, a television (TV) station office server provides a plurality of TV program groups at a same time for a set top box (STB) over multiple channels, respectively. Each channel corresponds to one TV program group. The TV station office server provides a plurality of frequencies to support the multiple channels, and each frequency support one or more channels.

For example, if a frequency range employed by the TV station office server is 87 MHz˜847 MHz and a frequency gap is 8 MHz, then all frequencies in the frequency range are 87 MHz, 95 MHz, 103 MHz, 111 MHz, . . . , and 847 MHz, which includes 96 frequencies in total. If the TV station office server employs 120 channels to transmit 120 TV program groups, the 120 channels are loaded by the 96 frequencies. In that case, some of the 96 frequencies supports one channel, and others of the 96 frequencies supports more than one channel. For example, a first frequency (87 MHz) supports a first channel, a second frequency (95 MHz) supports a second channel and a third channel, a third frequency (103 MHz) supports a fourth channel, . . . , and so on. In those frequencies which support several channels to transmit several TV program groups, the TV station office server transforms the several TV program groups into a transport stream (TS) by way of employing a frequency division multiplexing (FDM) technology, and transmits the transport stream with the frequencies.

One way is to establish a TV program table, where the STB needs to search 120 channels which are supported by the 96 frequencies provided by the TV station office server in sequence. For example, the original set top box can switch to the first frequency (such as 87 MHz) and searches all channels supported by the first frequency, and then switches to the second frequency (such as 95 MHz) and searches all channels supported by the second frequency, . . . , until all frequencies are searched. In that case, the set top box would cost rather long time to establish the TV program table. Therefore, a method of establishing the TV program table rapidly is desired.

### BRIEF DESCRIPTION OF THE DRAWINGS

The details of the disclosure, both as to its structure and operation, can best be understood by referring to the accompanying drawings, in which like reference numbers and designations refer to like elements.

FIG. 1 is a schematic diagram of an application environment of one embodiment of a set top box of the present disclosure;

FIG. 2 is a schematic diagram of functional modules of one embodiment of the set top box of FIG. 1;

FIG. 3 is a flowchart of one embodiment of a method of establishing television (TV) program table of the present disclosure; and

FIG. 4 is a flowchart of another embodiment of the method of establishing TV program table of the present disclosure.

### DETAILED DESCRIPTION

All of the processes described may be embodied in, and fully automated via, software code modules executed by one or more general purpose computers or processors. The code modules may be supported by any type of computer-readable medium or other storage device. Some or all of the methods may alternatively be embodied in predeterminedized computer hardware or communication apparatus.

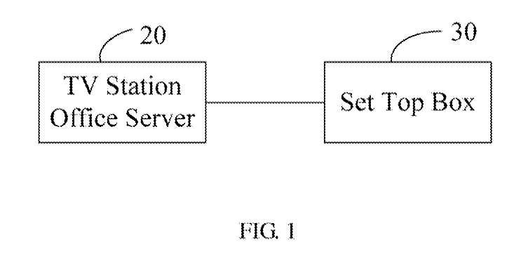

FIG. 1 is a schematic diagram of an application environment of one embodiment of a set top box 30 of the present disclosure. In one embodiment, the set top box 30 connects to a television (TV) station office server 20 via a communication network, and forms a cable television (CATV) system with the TV station office server 20 collectively.

In one embodiment, the TV station office server 20 provides a plurality of TV programs groups for the set top box 30 over multiple channels of the TV station office server 20. As mentioned earlier, each channel corresponds to one TV program group. The TV station office server 20 provides a plurality of frequencies to support the multiple channels, and each frequency support one or more channels. Each TV program group is transmitted over one channel of the TV station office server 20, and each frequency is configured to transmit one or more TV program groups. The TV program groups may comprise related TV programs, such as sports, cooking, travelling, for example.

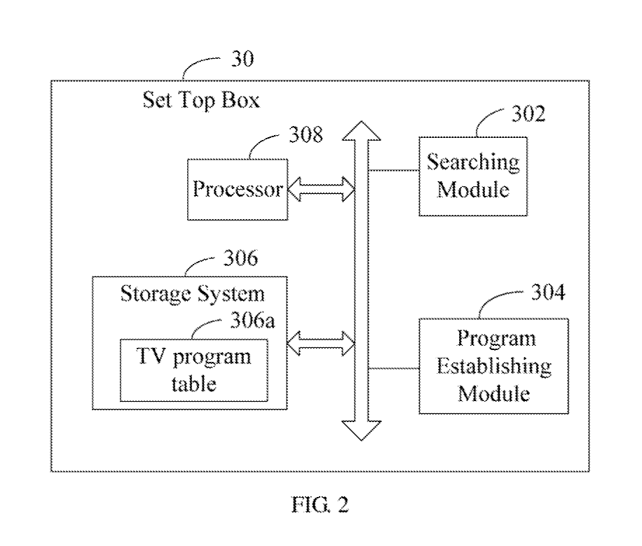

FIG. 2 is a schematic diagram of functional modules of one embodiment of the set top box 30 of FIG. 1. In one embodiment, the set top box 30 comprises a searching module 302, a program establishing module 304, a storage system 306, and at least a processor 308. The modules 302-304 may comprise computerized codes in the form of one or more programs that are stored in the storage system 306. The computerized code comprises instructions that are executed by the at least one processor 308 to provide functions of the modules 302-304.

The TV station office server 20 selects a predetermined channel among the multiple channels to transmit an extensible markup language (XML) file comprising TV program information to the set top box 30. In one embodiment, the predetermined channel is selected from the multiple channels, and the TV program information comprises information regarding the plurality of TV program groups which are transmitted to the set top box 30 by the TV station office server 20. The TV program information comprises a program association table (PAT), a program map table (PMT), and a service description table (SDT) of each of the plurality of TV program groups.

The searching module 302 searches the predetermined channel provided to obtain the XML file. In one embodiment, the searching module 302 obtains a frequency of the predetermined channel from a network information table (NIT) transmitted by the TV station office server 20 when the set top box 30 is used at the first time. After obtaining the frequency, the searching module 302 scans the frequency to search the predetermined channel and then obtains the XML file.

The searching module 302 determines whether the XML file is received over the predetermined channel. If the XML file is not received over the predetermined channel, the program establishing module 304 establishes the TV program table 306a in a traditional way, namely the searching module 302 searches all the multiple channels provided by the TV station office server 20 one by one to obtain the PAT, the PMT, and the SDT of each of the plurality of TV program groups, and establishes the TV program table 306a according to the PAT, the PMT, and the SDT of each of the plurality of TV program groups. This way is time cost.

The program establishing module 304 analyzes the XML file with an XML analysis program if the XML file is received over the predetermined channel provided by the TV station office server 20. In one embodiment, the program establishing module 304 analyzes the XML file via the XML analysis program to obtain the TV program information, namely to obtain the PAT, the PMT, and the SDT of each of the plurality of TV program groups.

The program establishing module 304 establishes the TV program table 306a according to the TV program information obtained from the XML file, namely according to the PAT, the PMT, and the SDT of each of the plurality of TV program groups to establish the TV program table 306a. In one embodiment, the program establishing module 304 stores the TV program table 306a in the storage system 306 after establishing the TV program table 306a.

In a traditional way, to establish the TV program table, the original set top box needs to search 120 channels which are supported by the 96 frequencies provided by the TV station office server 20 in sequence. In one exemplary embodiment, the set top box 30 takes about 2 seconds to search one channel, and takes about 240 seconds to search all the 120 channels to establish the TV program table.

In the present disclosure, each TV program group information in the XML format may be about 8˜16K bits, so if the TV station office server 20 provides 120 TV program groups over 120 channels to the set top box 30, the XML file including all TV program groups information may be about 960˜1920K bits. Assuming a transmission rate of the predetermined channel is 100K bits per second, it would take about 9.6˜19.2 seconds to transmits the XML file to the set top box 30, and take about 20˜30 seconds to establish the TV program table. That is, the set top box 30 of the embodiment would establish the TV program table with at most 49.2 s. In comparison, the set top box 30 of the embodiment takes less time to establish the TV program table than the traditional way.

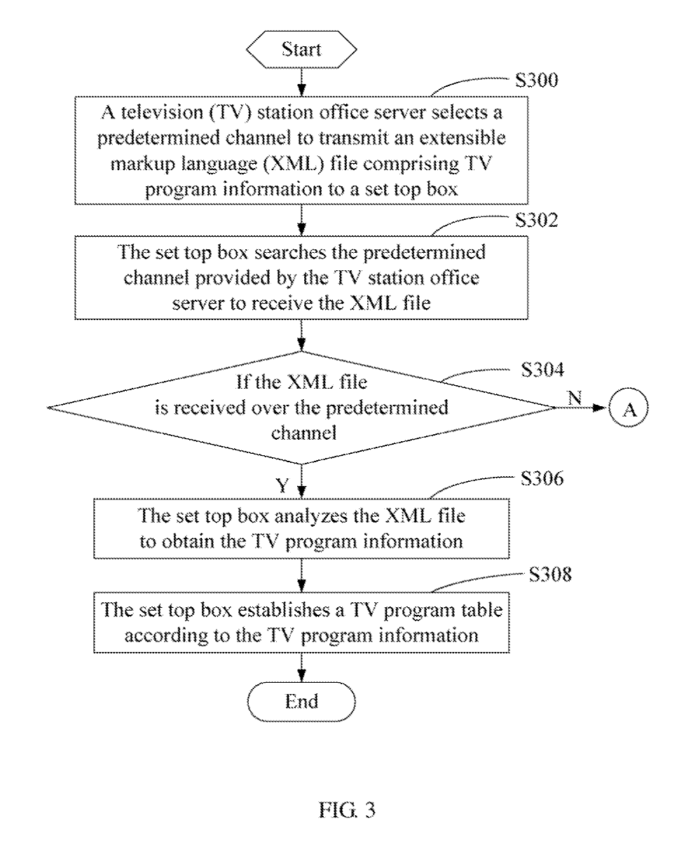

FIG. 3 is a flowchart of one embodiment of a method of establishing TV program table of the present disclosure. The flowchart is executed by the modules of FIG. 2. Depending on the embodiment, additional blocks may be added, others deleted, and the ordering of blocks may be changed while remaining well within the scope of the disclosure.

In block S300, the TV station office server 20 selects the predetermined channel among the multiple channels to transmit the XML file comprising TV program information to the set top box 30. In one embodiment, the predetermined channel is selected from the multiple channels, and the TV program information comprises information regarding the plurality of TV program groups which are transmitted to the set top box 30 by the TV station office server 20. The TV program information comprises the PAT, the PMT, and the SDT of each of the plurality of TV program groups.

In block S302, the searching module 302 searches the predetermined channel provided by the TV station office server 20 to obtain the XML file. In one embodiment, the searching module 302 obtains the frequency of the predetermined channel from the NIT transmitted by the TV station office server 20 when the set top box 30 is used at the first time. After obtaining the frequency, the searching module 302 scans the frequency to search the predetermined channel and then obtains the XML file.

In block S304, the searching module 302 determines whether the XML file is received over the predetermined channel.

If the XML file is received over the predetermined channel, then in block S306, the program establishing module 304 analyzes the XML file with the XML analysis program. In one embodiment, the program establishing module 304 analyzes the XML file via the XML analysis program to obtain the TV program information, namely to obtain the PAT, the PMT, and the SDT of each of the plurality of TV program groups.

In block S308, the program establishing module 304 establishes the TV program table 306a according to the TV program information obtained from the XML file, namely according to the PAT, the PMT, and the SDT of each of the plurality of TV program groups to establish the TV program table 306a. In one embodiment, the program establishing module 304 stores the TV program table 306a in the storage system 306 after establishing the TV program table 306a.

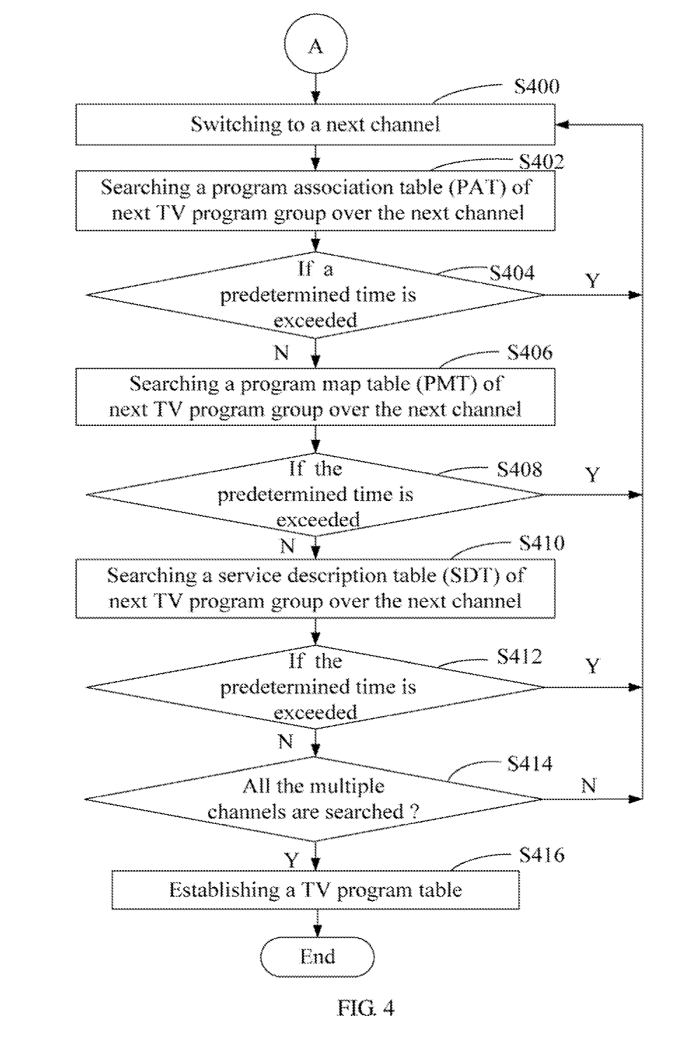

On the contrary, if the XML file is not received over the predetermined channel, the program establishing module 304 establishes the TV program table 306a in the traditional way which under in block S400˜S420, shown as in FIG. 4.

FIG. 4 is a flowchart of another embodiment of the method of establishing TV program table of the present disclosure. The flowchart is executed by the modules of FIG. 2. Depending on the embodiment, additional blocks may be added, others deleted, and the ordering of blocks may be changed while remaining well within the scope of the disclosure.

In block S400, the searching module 302 of the set top box 30 switches to a next channel of the TV station office server 20 if the XML file is not received over the predetermined channel.

In block S402, the searching module 302 searches the PAT of next TV program group over the next channel. In one embodiment, the packet identity of the PAT is 0x0000, so the searching module 302 searches packets which the packet identity is 0x0000 to obtain the PAT, and obtain a packet identity of the PMT of the next channel from the PAT.

In block S404, the searching module 302 determines if a predetermined time is exceeded during searching the PAT. In one embodiment, the set top box 30 configures the predetermined time (such as 2 s) to search the PAT, the PMT, and the SDT of each TV program group transmitted in each channel. If the predetermined time is exceeded and the PAT (or the PMT, or the SDT) is not obtained, the searching module 302 switches to another channel, shown as in block S400.

If the predetermined time is not exceeded during searching the PAT, in block S406, the searching module 302 searches the PMT of next TV program group over the next channel. In one embodiment, the packet identity of the PMT is provided by the PAT, so the searching module 302 searches the PMT according to the packet identity of the PMT. For example, if the packet identity of the PMT provided by the PAT is 0x0111, the searching module 302 searches packets which the packet identity is 0x0111 to obtain the PMT.

In block S408, the searching module 302 determines if the predetermined time is exceeded during searching the PMT.

If the predetermined time is not exceeded during searching the PMT, in block S410, the searching module 302 searches the SDT of next TV program group over the next channel. In one embodiment, the packet identity of the SDT is 0x00011, so the searching module 302 searches packets which the packet identity is 0x0011 to obtain the SDT.

In block S412, the searching module 302 determines if the predetermined time is exceeded during searching the SDT.

If the predetermined time is not exceeded during searching the SDT, in block S414, the searching module 302 determines whether all the multiple channels are searched. For example, if the TV station office server 20 provides 120 channels, the searching module 302 determines if all the 120 channels are searched.

If all the multiple channels are not searched, in block S400, the searching module 302 switches to another channel. On the contrary, if all the multiple channels are searched, in block S416, the program establishing module 304 establishes the TV program table 306a according to the PAT, the PMT, and the SDT of each of the plurality of TV program groups, and stores the TV program table 306a in the storage system 306.

While various embodiments of the present disclosure have been described above, it should be understood that they have been presented by way of example only and not by way of limitation. Thus the breadth and scope of the present disclosure should not be limited by the above-described embodiments, but should be defined only in accordance with the following claims and their equivalents.

What is claimed is:

1. A set top box in communication with a television (TV) station office server, the set top box comprising:
at least one processor;
a storage system; and
one or more programs that are stored in the memory and are executed by the at least one processor, the one or more programs comprising:
a searching module operable to search a predetermined channel among multiple channels of the TV station office server, and to receive an extensible markup language (XML) file comprising TV program information transmitted by the TV station office server over the predetermined channel, wherein the TV program information comprises information regarding a plurality of TV program groups; and
a program establishing module operable to analyze the XML file to obtain the TV program information, and to establish a TV program table according to the TV program information.

2. The set top box as claimed in claim 1, wherein the TV program information comprises a program association table (PAT), a program map table (PMT), and a service description table (SDT) of each of the plurality of TV program groups.

3. The set top box as claimed in claim 2, wherein the program establishing module establishes the TV program table according to the PAT, the PMT, and the SDT of each of the plurality of TV program groups.

4. The set top box as claimed in claim 2, wherein the searching module further obtains frequency of the predetermined channel from a network information table (NIT) transmitted to the set top box by the TV station office server, and scans the frequency of the predetermined channel to search the predetermined channel.

5. The set top box as claimed in claim 2, wherein the searching module is further operable to switch to a next channel of the TV station office server if the XML file is not received over the predetermined channel.

6. The set top box as claimed in claim 5, wherein the searching module is further operable to search the PAT, the PMT, and the SDT of one TV program group which transmitted over the next channel of the TV station office server, and to determine whether the PAT, the PMT, and the SDT of the one TV program group are obtained in a predetermined time.

7. The set top box as claimed in claim 6, wherein the searching module is further operable to switch to another channel of the TV station office server if the PAT, the PMT, and the SDT of the one TV program group are not obtained in the predetermined time.

8. The set top box as claimed in claim 7, wherein the searching module is further operable to determine whether all the multiple channels are searched, and to switch to another channel of the TV station office server when all the multiple channels are not searched.

9. The set top box as claimed in claim 8, wherein the program establishing module is further operable to establish the TV program table according to the PAT, the PMT, and the SDT of each of the plurality of TV program groups when all the pluralities of channels are searched.

10. A method of establishing TV program table in a set top box, the set top box communicating with a TV station office server which provides a plurality of TV program groups for the set top box over multiple channels, the method of establishing the TV program table comprising:
searching a predetermined channel among the multiple channels of the TV station office server to receive an extensible markup language (XML) file comprising TV program information transmitted by the TV station office server over the predetermined channel, wherein the TV program information comprises information regarding a plurality of TV program groups;
determining whether the XML file is received over the predetermined channel;
analysing the XML file to obtain the TV program information if the XML file is received over the predetermined channel; and
establishing a TV program table according to the TV program information.

11. The method of establishing the TV program table as claimed in claim 10, wherein the TV program information comprises a program association table (PAT), a program map table (PMT), and a service description table (SDT) of each of the plurality of TV program groups.

12. The method of establishing the TV program table as claimed in claim 11, further comprising: establishing the TV program table according to the PAT, the PMT, and the SDT of each of the plurality of TV program groups.

13. The method of establishing the TV program table as claimed in claim 12, further comprising:
switching to a next channel of the TV station office server if the XML file is not received over the predetermined channel;
searching the PAT of next TV program group over the next channel;
determining whether a predetermined time is exceeded during searching the PAT;
searching the PMT of next TV program group over the next channel of the TV station office server if the predetermined time is not exceed during searching the PAT;
determining whether the predetermined time is exceeded during searching the PMT;
searching the SDT of next TV program group over the next channel of the TV station office server if the predetermined time is not exceed during searching the PMT;
determining whether the predetermined time is exceeded during searching the SDT;
determining whether all the multiple channels are searched if the predetermined time is not exceeded during searching the SDT; and
establishing the TV program table according to the PAT, the PMT, and the SDT of each of the plurality of TV program groups if all the multiple channels are searched.

14. The method of establishing the TV program table as claimed in claim 13, further comprising: switching to another channel of the TV station office server if the predetermined time is exceeded during searching the PAT.

15. The method of establishing the TV program table as claimed in claim 13, further comprising: switching to another channel of the TV station office server if the predetermined time is exceeded during searching the PMT.

16. The method of establishing the TV program table as claimed in claim 13, further comprising: switching to another channel of the TV station office server if the predetermined time is exceeded during searching the SDT.

17. The method of establishing the TV program table as claimed in claim 13, further comprising: switching to another channel of the TV station office server if all the multiple channels are not searched.
